(19) United States
(12) Patent Application Publication
(10) Pub. No.: US 2016/0032142 A1
(43) Pub. Date: Feb. 4, 2016

(54) TWO-COMPONENT COATING COMPOSITION

(71) Applicant: AXALTA COATING SYSTEMS IP CO., LLC, Wilmington, DE (US)

(72) Inventors: Jozef Huybrechts, Turnhout (BE); Leen Tanghe, Kontich (BE); Ann Vaes, Putte (BE)

(73) Assignee: AXALTA COATING SYSTEMS IP CO., LLC, Wilmington, DE (US)

(21) Appl. No.: 14/772,591

(22) PCT Filed: Mar. 4, 2014
(86) PCT No.: PCT/US2014/020283

§ 371 Date: Sep. 3, 2015

Related U.S. Application Data
(60) Provisional application No. 61/773,373, filed on Mar. 6, 2013.

(51) Int. Cl. C09D 175/06; B05D 7/16; B05D 7/00

(52) U.S. Cl. CPC C09D 175/06; B05D 7/572; B05D 7/542; B05D 7/16

(57) ABSTRACT

The invention relates to a coating composition comprising (A) at least one polyaspartic acid ester, (B) at least one polyisocyanate cross-linking agent with free isocyanate groups and (C) at least one compound with at least one epoxy group and at least one alkoxy silane group and to the use of the coating composition as primer, primer surfacer, pigmented single stage top coat or clear coat coating composition, particularly in vehicle repair coating.

### CROSS-REFERENCE TO RELATED APPLICATION

This application is a U.S. National-Stage entry under 35 U.S.C. §371 based on International Application No. PCT/US2014/020283, filed Mar. 4, 2014 which was published under PCT Article 21(2) and which claims the benefit of U.S. Provisional Application No. 61/773,373, filed Mar. 6, 2013.

### TECHNICAL FIELD

The present disclosure relates to a two-component coating composition comprising an isocyanate reactive component and a polyisocyanate curing agent. The coating composition of this invention can particularly be used as clear coat coating composition in a process for producing a multilayer coating, which process may in particular be used for coating vehicle bodies and vehicle body parts.

### BACKGROUND

Aspartate based coating compositions are well known in the art. For example, EP 0403921 describes coating compositions with binders based on a polyisocyanate component and an isocyanate-reactive component containing specific secondary polyamines. These secondary polyamines are also called polyaspartic acid esters and are based on reaction products of primary polyamines and diesters of maleic and/or fumaric acid.

EP 0470461 also describes coating compositions for vehicle refinish applications containing a polyisocyanate component and an isocyanate-reactive secondary diamine prepared from 3,3′-dimethyl 4,4′-diamino dicyclohexylmethane and maleic acid diethylester. The isocyanate-reactive component further contains a hydroxyl functional binder consisting of poly(meth)acrylates or mixtures of poly(meth)acrylates and polyester polyols.

A disadvantage of the above aspartate based coating compositions is that even though they possess fast curing times, they do not provide adequate pot life for certain applications, i.e. the viscosity of those compositions increases too rapidly after mixing the components and prior to the application of the coating composition to a substrate. Furthermore, those coating compositions based on aspartates and blends of polyols and aspartates cause yellowing in the pot and upon blending with the polyisocyanate and do not provide acceptable interlayer adhesion in a multi-layer structure. Coatings of aspartate containing clear coat coating compositions in particular lack adequate adhesion on pigmented water-based base coat coating compositions. A further disadvantage of the above coating compositions and the resultant coatings is poor resistance to alcohols.

Furthermore, WO 2010/112157 discloses anticorrosive primers containing polyaspartates and silane-functional polyisocyanates.

WO 2009/086026 discloses a transparent organic solvent-based clear coat coating composition comprising at least one binder with functional groups containing active hydrogen, in particular hydroxyl groups, at least one polyisocyanate cross-linking agent with free isocyanate groups and at least one epoxy-functional silane. These coating compositions exhibit good adhesion properties. In particular a multilayer structure containing the clear coat coating composition has adequate interlayer adhesion, for example, on a water-borne base coat layer. These clear coat coating compositions do not contain isocyanate reactive polyaspartic acid esters.

It has not hitherto been possible to provide a satisfactory solution to improve adhesion on a substrate or interlayer adhesion of a two-component formulation based on aspartic acid esters and polyisocyanates which does not simultaneously substantially impair other important coating properties, such as the pot life, VOC content (VOC=Volatile Organic Compound), drying characteristics, stability and optical properties of the resultant coatings.

Thus, it is desirable to provide coating compositions, in particular clear coat coating compositions, which do not have the disadvantages of prior art two-component coating systems. In particular it is desirable to provide fast curing clear coat coating compositions with acceptable pot life, which do not show yellowing in the pot after mixing and yellowing of the aspartate based component on storage, and which yield coatings with very good humidity resistance and adhesion properties, e.g. satisfactory wet and dry interlayer adhesion, in particular with very good initial wet and dry adhesion to a prior coating, such as a layer of a water-based base coat coating composition. In addition the coating compositions shall lead to coatings with very good resistance to alcohols. In addition, other objects, desirable features and characteristics will become apparent from the subsequent summary and detailed description, and the appended claims, taken in conjunction with the accompanying drawings and this background.

### SUMMARY

In accordance with an exemplary embodiment, a coating composition comprise:

(A) at least one polyaspartic acid ester,

(B) at least one polyisocyanate cross-linking agent with free isocyanate groups, and

(C) at least one compound with at least one alkoxy silane group and at least one epoxy group.

### DETAILED DESCRIPTION OF THE INVENTION

The following detailed description is merely exemplary in nature and is not intended to limit the invention or the application and uses of the invention. Furthermore, there is no intention to be bound by any theory presented in the preceding background of the invention or the following detailed description.

It will be appreciated that certain features of the invention which are, for clarity, described above and below in the context of separate embodiments may also be provided in combination in a single embodiment. Conversely, various features of the invention that are, for brevity, described in the context of a single embodiment may also be provided separately or in any sub-combination. In addition, references in the singular may also include the plural (for example, “a” and “an” may refer to one, or one or more) unless the context specifically states otherwise.

The term (meth)acrylic as used here and hereinafter should be taken to mean methacrylic and/or acrylic.

Unless stated otherwise, all molecular weights (both number and weight average molecular weight) referred to herein are determined by GPC (gel permeation chromatographie) using polystyrene as the standard and tetrahydrofurane as the liquid phase eluent.

Water-based coating compositions are coating compositions, wherein water is used as solvent or thinner when preparing and/or applying the coating composition. Usually, water-based coating compositions may contain, for example, 30 to 90% by weight of water, based on the total amount of the coating composition and optionally, up to 30% by weight, preferably, below 15% by weight of organic solvents, based on the total amount of the coating composition.

Organic solvent-based coating compositions are coating compositions, wherein organic solvents are used as solvents or thinner when preparing and/or applying the coating composition. Usually, solvent-based coating compositions contain, for example, 10 to 90% by weight of organic solvents, based on the total amount of the coating composition.

The pot life is the time within which, once the mutually reactive components of a coating composition have been mixed, the coating composition may still be properly processed or applied and coatings of unimpaired quality may be achieved.

The coating composition is a two-component coating composition, i.e. the components which are reactive towards one another, namely the polyaspartic acid ester (A) and the polyisocyanate cross-linking agent (B), must be stored separately from one another prior to application in order to avoid a premature reaction. Generally component (A) and polyisocyanate component (B) may only be mixed together shortly before application. The term “shortly before application” is well-known to a person skilled in the art. The time period within which the ready-to-use coating composition may be prepared prior to the actual use/application depends, e.g., on the pot life of the coating composition.

Component (A)

The coating composition according to an embodiment comprises at least one polyaspartic acid ester.

Preferably the at least one polyaspartic acid ester corresponds to Formula (I):

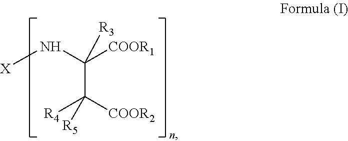

wherein X represents an n-valent organic group, preferably a divalent hydrocarbon group, obtained by removal of the amino groups from a primary polyamine or polyetheramine; R1 and R2 are the same or different organic groups which are inert towards isocyanate groups. R3, R4 and R5 are the same or different and represent hydrogen or organic groups which are inert towards isocyanate groups, and n represents an integer with a value of at least 2, preferably 2 to 4 and more preferably 2. X preferably represents a divalent hydrocarbon group obtained by removal of the amino groups from the primary polyamines and polyetheramines mentioned below and more preferably represents a divalent hydrocarbon group obtained by removal of the amino groups from the preferred primary polyamines mentioned below. R1 and R2 are the same or different residues and are preferably methyl, ethyl or n-butyl and R3, R4 and R5 are preferably hydrogen.

An organic group which is inert towards isocyanate groups is preferably an organic group which is inert towards isocyanate groups at a temperature of 150° C. or less. Polyaspartic acid esters of formula (I) are prepared in known manner by reacting the corresponding primary polyamines or polyether amines corresponding to the formula X—(NH2)n with optionally substituted maleic or fumaric acid esters corresponding to the formula R1OOC—CR3=CR4-COOR2. X, R1, R2, R3, R4 and n have the meaning as defined above for Formula (I).

Primary polyamines or polyether amines are preferred for preparing the polyaspartic acid esters as those give a favorable solids/viscosity ratio in order to meet the desired VOC of 3.5 lbs/gal (420 grams/liter) or below of the final formulation. A molar excess of those polyamines or polyether amines can also be reacted with di- and polyisocyanates to prepare amine terminated ureas or polyether ureas, or can be reacted with isocyanate terminated polyesters, polycarbonates or polyethers obtained from the corresponding polyester, polycarbonate or polyether di- or polyols, and subsequent conversion of the terminal amine groups into an aspartic acid ester through reaction with a maleic and/or fumaric acid ester.

Suitable primary polyamines include ethylene diamine, 1,2-diaminopropane, 1,4-diaminobutane, 1,3-diaminopentane, 1,6-diaminohexane, 2,5-diamino-2,5-dimethylhexane, 2,2,4- and 2,4,4-trimethyl-1,6-diaminohexane, 1,11-diaminoundecane, 1,12-diaminododecane, 1,3- and 1,4-cyclohexane diamine, 1-amino-3,3,5-trimethyl-5-aminomethylcyclohexane, 2,4- and 2,6-hexahydrotoluylene diamine, 2,4′- and 4,4′-diamino-dicyclohexyl methane and 3,3′-dialkyl-4,4′-diaminodicyclohexylmethanes, such as 3,3′-dimethyl-4,4′-diaminodicyclohexyl methane and 3,3′-diethyl-4,4′-diaminodicyclohexylmethane, 2,4,4′-triamino-5-methyldicyclohexylmethane, 2-methyl-1,5-pentanediamine and 1,3- and 1,4 xylylenediamine. Preferred primary polyamines are amino-3,3,5-trimethyl-5-aminomethylcyclohexane (IPDI), 2,4′- and 4,4′-diamino-dicyclohexyl methane, 3,3′-dialkyl-4,4′-diaminodicyclohexylmethanes such as 3,3′-dimethyl-4,4′-diaminodicyclohexyl methane and 2-methyl-1,5-pentanediamine.

Suitable polyether polyamines are those with aliphatically bonded primary amino groups. The polyether polyamines can have a molecular weight of 148 to 6,000. Examples of suitable polyether polyamines are the products commercially available under the trademark JEFFAMINE® from Huntsman.

Examples of optionally substituted maleic or fumaric acid esters suitable for preparing the polyaspartic acid esters include the dimethyl, diethyl, dibutyl (e. g. di-n-butyl,di-s-butyl,di-t-butyl), diamyl, di-2-ethylhexyl esters and mixed esters based on mixtures of the above and/or other alkyl groups, and the corresponding maleic and fumaric acid esters substituted by methyl in the 2- and/or 3-position. The dimethyl, diethyl and dibutyl esters of maleic acid are preferred, while the diethyl esters are especially preferred.

Other diesters which can be used are those derived from cycloaliphatic, bicycloaliphatic and aromatic alcohols, such as cyclohexanol, benzylalcohol and isoborneol. Long chain monoalcohols such as ether alcohols can also be used, e.g., the reaction products of monoalkyl, cycloalkyl and aryl monoalcohols with ethyleneoxide, propyleneoxide, butyleneoxide, such as monobutylglycol, monohexylglycol, propyleneglycol monobutylether.

The preparation of polyaspartic acid ester of Formula (I) from the above mentioned starting materials may be carried out, for example, at a temperature of from 0 to 150° C. using the starting materials in such proportions that at least 1, preferably 1, olefinic double bond is present for each primary amino group. Excess of starting materials may be removed by distillation after the reaction. The reaction may be carried out solvent-free or in the presence of suitable organic solvents such as alcohols, ethers, acetates and ketones, e.g., methanol, ethanol, propanol, n-butyl acetate, butylglycol, methylethylketone, dioxane, and mixtures of such organic solvents. Preferred solvents are those which are not reactive with isocyanates.

Component (B)

The coating compositions according to an embodiment comprise polyisocyanate cross-linking agents with free isocyanate groups (component B). The polyisocyanates can be any number of organic polyisocyanates with aliphatically, cycloaliphatically, araliphatically and/or aromatically bound free isocyanate groups. The polyisocyanates are liquid at room temperature or become liquid through the addition of organic solvents. At 23° C., the polyisocyanates generally have a viscosity of 1 to 3,500 mPas, preferably of 5 to 3,000 mPas.

The preferred polyisocyanates are polyisocyanates or polyisocyanate mixtures with exclusively aliphatically and/or cycloaliphatically bound isocyanate groups with an average NCO functionality of 1.5 to 6, preferably 2 to 6.

Examples of particularly suitable polyisocyanates are what are known as “paint polyisocyanates” based on hexamethylene diisocyanate (HDI), 1-isocyanato-3,3,5-trimethyl-5-isocyanatomethyl-cyclohexane (IPDI) and/or bis(isocyanatocyclohexyl)-methane and the derivatives known per se, containing biuret, allophanate, urethane and/or isocyanurate groups of these diisocyanates. Typically, following production, the derivatives are freed from surplus parent diisocyanate, preferably by distillation, with only a residue content of less than 0.5% by weight. Triisocyanates, such as triisocyanatononan can also be used.

Sterically hindered polyisocyanates are also suitable. Examples of these are 1,1,6,6-tetramethyl-hexamethylene diisocyanate, 1,5-dibutyl-penta-methyldiisocyanate, p- or m-tetramethylxylylene diisocyanate and the appropriate hydrated homologues. In principle, diisocyanates can be converted by the usual processes to higher functional compounds, for example, by trimerization or by reaction with water or polyols, such as, for example, trimethylolpropane or glycerine. The polyisocyanates can also be used in the form of isocyanate-modified resins or isocyanate-functional pre-polymers. Generally the polyisocyanates can be isocyanurates, uretdione diisocyanates, biuret group-containing polyisocyanates, urethane group-containing polyisocyanates, allophanate group-containing polyisocyanates, isocyanurate and allophanate group-containing polyisocyanates, carbodiimide group-containing polyisocyanates and polyisocyanates containing acylurea groups.

The polyisocyanate cross-linking agents can be used individually or in combination with one another. The polyisocyanate cross-linking agents are those commonly used in the paint industry. They are described in detail in the literature and are also commercially obtainable. The isocyanate groups of polyisocyanate crosslinking agent B) may be partially blocked. Low molecular weight compounds containing active hydrogen for blocking NCO groups are known. Examples of those blocking agents are aliphatic or cycloaliphatic alcohols, dialkylamino alcohols, oximes, lactams, imides, hydroxyalkyl esters and esters of malonic or acetoacetic acid.

Component (C)

The coating composition according to an embodiment comprises at least one compound containing at least one alkoxy silane group and at least one epoxy group. Preferably the at least one compound containing at least one alkoxy silane group and at least one epoxy group is not a polyaspartic acid ester and is not a polyisocyanate. Compounds C) can be monomeric, oligomeric or polymeric compounds. Examples of suitable monomeric oligomeric or polymeric compounds C) are those compounds having at least one alkoxy silane group corresponding to Formula (II)

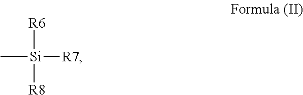

wherein R6, R7, R8 are the same or different organic groups with 1 to 30 carbon atoms per molecule, provided that at least one of the residues R6, R7 and R8 is an alkoxy group with 1 to 4 carbon atoms.

Monomeric, polymeric and oligomeric compounds C) contain in addition to the alkoxy silane group at least one epoxy group.

According to one embodiment the at least one compound C) with at least one alkoxy silane group and at least one epoxy group is a monomeric compound, preferably a compound of the general Formula (III):

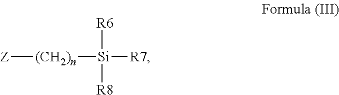

wherein Z represents the residues

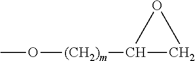

with m being 1-4; or represents 3,4-epoxycyclohexyl; R6, R7, R8 are the same or different organic residues with 1 to 30 carbon atoms, provided that at least one of the residues R6, R7 and R8 is an alkoxy group with 1 to 4 carbon atoms; and n is 2, 3 or 4, preferably 2 or 3.

Preferred compounds of the formula (III) are those in which Z is

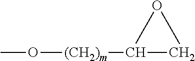

with m being 1 to 4.

Compounds in which R6, R7 and R8 are the same or different alkoxy groups having 1 to 4, preferably 1, 2 or 3 carbon atoms are likewise preferred. Particularly preferred alkoxy groups are methoxy, ethoxy and isopropoxy groups.

Examples of particularly suitable epoxy-functional silane compounds of the general formula (III) are (3-glycidoxypropyl)trimethoxysilane, (3-glycidoxypropyl)triethoxysilane, (3-glycidoxypropyl)triisopropoxysilane, beta-(3,4-epoxycyclohexyl)ethyltrimethoxysilane and beta-(3,4-epoxycyclohexyl)ethyltriethoxysilane. Silanes with methoxy groups, such as for example (3-glycidoxypropyl)trimethoxysilane and beta-(3,4-epoxycyclohexyl)ethyltrimethoxy-silane are particularly preferred here.

Epoxy-functional silane compounds of Formula (III) which may be used are also obtainable as commercial products, for example under the trade name DYNASILAN® Glymo from Degussa, SILQUEST® A187 and SILQUEST® A186 from ACC Silicones.

Examples of polymeric components C) are (meth)acrylic copolymers with at least one alkoxy silane group and at least one epoxy group.

The compounds C), specifically the preferred compounds of Formula (III) can be used in amounts of 0.25 to 5.0% by weight solids, in particular of 0.8 to 3.0% by weight solids and most preferred of 2.0 to 3.0% by weight solids, relative to the sum of the solids content of component A) and component B). If component C) is used in quantities of greater than 5.0% by weight solids this can lead to inferior viscosity and color stability of the coating composition and hardness development of the multilayer coating. If component C) is used in quantities of less than 0.25% by weight solids the described positive effects, specifically the adhesion effects, cannot be achieved.

The coating composition may comprise in addition to component A), hydroxyl-functional binders. The hydroxyl-functional binders may be oligomeric and/or polymeric compounds with a number average molecular weight (Mn) of, e.g., 500 to 500,000 g/mole, preferably of 1,100 to 100,000 g/mole. The binders with hydroxyl groups are for example the polyurethanes, (meth)acrylic copolymers, polyesters and polyethers, known from polyurethane chemistry to the skilled person, which are used in the formulation of, e.g., organic solvent based coating compositions. They may each be used individually or in combination with one another

Examples of hydroxyl-functional (meth)acrylic copolymers include all (meth)acrylic copolymers which are suited for organic solvent based coating compositions and known to a skilled person. For example, they can be those with a number average molar mass Mn of 1,000-20,000 g/mol, preferably, of 1,100-15,000, an acid value of 0-100 mg KOH/g, and a hydroxyl value of 40-400 mg KOH/g, preferably, of 60-200 mg KOH/g. The (meth)acrylic copolymers can be prepared by free-radical polymerization of polymerizable, olefinically unsaturated monomers, optionally, in presence of oligomeric or polymeric polyester and/or polyurethane resins. Free-radically polymerizable olefinically unsaturated monomers, which may be used are monomers which, in addition to at least one olefinic double bond, also contain further functional groups and monomers which, apart from at least one olefinic double bond, contain no further functional groups.

Examples of hydroxyl-functional polyester resins which can be used as binder include all polyester resins which are suited for organic solvent-based coating compositions, for example, hydroxyl-functional polyesters with a number average molecular weight of 500-10,000 g/mol, preferably, of 1100-8000 g/mol, an acid value of 10-150 mg KOH/g, preferably, of 15-50 mg KOH/g and a hydroxyl value of 40-400 mg KOH/g, preferably, of 50-200 g/mol. The polyesters may be saturated or unsaturated and they may optionally be modified with fatty acids. The polyesters are produced using known processes with elimination of water from polycarboxylic acids and polyalcohols.

Examples of suitable hydroxyl-functional polyurethanes include all polyurethane resins which are suited for coating compositions and known to a skilled person. Examples are polyurethanes, for example, with a number average molar mass Mn of 500 to 500,000 g/mole, preferably, of 1,100 to 300,000 g/mole, most preferably, of 5,000 to 300,000 g/mole, an acid value of 0 to 100 mg KOH/g, and a hydroxyl value of 40 to 400 mg KOH/g, preferably, of 80 to 250 mg KOH/g. Appropriate polyurethane resins which may be used are, for example, prepared by reacting compounds which are reactive with respect to isocyanate groups and polyisocyanates having at least 2 free isocyanate groups per molecule.

If hydroxyl-functional binders are present in addition to component A) preferably hydroxyl-functional (meth)acrylic copolymers are used.

If hydroxyl-functional binders are present in addition to component A) the hydroxyl-functional binders are present in amounts of less than 50% by weight, for example 5 to 10% by weight, based on total binder solids (sum of polyaspartic acid ester solids+hydroxyl-functional binder solids). The hydroxyl-functional binder has a hydroxyl value below 400 mg KOH/g solids, preferably of 10 to 260 mg KOH/g solids.

If the amount of the hydroxyl-functional binder or the hydroxyl number exceeds the above values, the pot life of the coating composition decreases drastically.

Preferably the coating compositions contemplated herein do not contain hydroxyl-functional binders. In a further embodiment the coating composition are free of blocked amines.

The coating compositions contemplated herein preferably comprise 20 to 80% by weight solids of the at least one polyaspartic acid ester (component A) and 20 to 80% by weight solids of the at least one polyisocyanate cross-linking agent with free isocyanate groups (component B), relative to the total amount of the binder solids of the coating composition (binder solids=aspartic acid ester solids+polyisocyanate solids).

The polyaspartic acid ester (A) and the cross-linking agent (B) are used in such quantity ratios that the equivalent ratio of secondary amino groups of component (A) to the isocyanate groups of cross-linking agent (B) is, for example, 5:1 to 1:5, preferably, 3:1 to 1:3, particularly preferably, 1.5:1 to 1:1.5. If further hydroxy-functional binders and reactive thinners are used, their reactive functions should be taken into consideration when calculating the equivalent ratio.

The alkoxysilane and epoxy functional compound (C) may be present in one of the two components or in both components of the two-component coating composition. Most preferred the alkoxysilane and epoxy functional compounds (C) are present in the polyisocyanate component (B).

In principle, the coating compositions can still be adjusted to spray viscosity with organic solvents prior to application. All the further components which are required for producing a usable coating composition, such as for example pigments, fillers, organic solvents and additives, may in each case be present in one of the two components or in both components of the two-component system.

In addition to components (A), (B) and (C) the coating composition contemplated herein may contain usual components to be used in coating compositions, such as pigments, fillers, additives and organic solvents. The pigments, fillers, additives and organic solvents are used in usual quantities known to a skilled person.

The organic solvents may originate from the preparation of the binders or they may be added separately. They are organic solvents typical of those used for coatings and well known to the skilled person.

The additives are the conventional additives, which may be used, in the coating sector, in particular in clear coats. Examples of such additives include light protecting agents, e.g., based on benzotriazoles and HALS compounds (hindered amine light stabilizers), leveling and flow agents based on (meth)acrylic homopolymers or silicone oils, rheology-influencing agents, such as, fine-particle silica or polymeric urea compounds, anti-foaming agents, wetting agents, curing catalysts for the cross-linking reaction, for example, organic metal salts, such as, dibutyltin dilaurate, zinc naphthenate and compounds containing tertiary amino groups such as triethylamine for the hydroxyl/isocyanate reaction.

Examples of pigments are color-imparting pigments, such as titanium dioxide, micronized titanium dioxide, iron oxide pigments, carbon black, azo pigments, phthalocyanine pigments, quinacridone and pyrrolopyrrole pigments as well as special effect-imparting, such as metallic pigments and interference pigments. Examples of fillers are silicon dioxide, aluminum silicate, aluminum oxide, barium sulfate and talcum.

According to a preferred embodiment the coating compositions comprise:

A) at least one di-aspartic acid ester,

B) at least one polyisocyanate cross-linking agent with free isocyanate groups, and

C) at least one alkoxysilane and epoxy-functional compound of the general Formula (III) as defined above.

The at least one di-aspartatic acid ester A) is preferably a compound corresponding to Formula (I) with n representing 2. More preferred it is a compound corresponding to Formula (I) with n representing 2, with X=dicyclohexylmethane, R1 and R2 being the same or different residues=methyl, ethyl or n-butyl and R3, R4 and R5=hydrogen.

The coating compositions contemplated herein can be used as pigmented coating compositions, e.g. as primer, primer surfacer and single stage top coat coating compositions, or as clear coat coating compositions. According to a preferred embodiment the coating compositions are clear coat coating compositions.

According to a further preferred embodiment the coating compositions as described above are organic solvent-based coating compositions.

More preferred the coating compositions as described above are organic solvent-based clear coat coating compositions.

Preferably the coating compositions as described above and any embodiments thereof are substantially free of hydroxyl-functional binders and hydroxyl-functional reactive thinners. More preferred they do not contain hydroxyl-functional binders and hydroxyl-functional reactive thinners.

Surprisingly it has been found that the combination of polyaspartic acid esters (A) and epoxy and alkoxysilane functional compounds (C) in the polyisocyanate containing coating compositions of the present invention allows to achieve both greatly improved humidity resistance and adhesion properties, i.e. greatly improved interlayer adhesion between the individual layers, e.g. after humidity/temperature strain as well as short drying times and an acceptable pot life of at least one hour after mixing the polyisocyanate component (B) with component (A). In particular base coat cohesion failure could be improved remarkably. Coatings obtained from the coating compositions have also very good resistance to alcohols, such as ethanol, n-butanol, isobutanol and isopropanol.

In accordance with another embodiment, a process (1) for the multilayer coating of substrates, in particular of vehicle bodies and vehicle body parts, comprises the following steps:

1. Applying a layer of a primer or primer surfacer coating composition onto an optionally pre-coated substrate,

2. Applying a layer of a base coat coating composition, preferably a water-based base coat coating composition, containing color and/or special effect pigments onto the primer or primer surfacer layer,

2. Applying a clear coat layer of a clear coat coating composition onto the base coat layer and

3. Curing the clear coat layer, optionally together with the base coat layer, wherein at least one of the primer coating composition, the primer surfacer coating composition and the clear coat coating composition being the coating composition as defined above.

According to another embodiment, a process (2) for the multilayer coating of substrates, in particular of vehicle bodies and vehicle body parts, comprises the following steps:

1. Applying a layer of a primer or primer surfacer coating composition onto an optionally pre-coated substrate,

2. Applying a layer of a pigmented single stage top coat layer onto the primer or primer surface layer, and

3. Curing the single stage top coat layer, optionally together with the primer or primer surface layer, wherein at least one of the primer coating composition, the primer surface coating composition and the pigmented single stage top coat coating composition being the coating composition as defined above.

The individual steps of the above processes are explained in greater detail below.

Process (1): In step 1 the primer or primer surfacer coating composition is applied onto an optionally pre-coated substrate. Suitable substrates are metal and plastic substrates, in particular the substrates known in the automotive industry, such as for example iron, zinc, aluminium, magnesium, stainless steel or the alloys thereof, polyurethanes, polycarbonates or polyolefines. The substrates may already be pre-coated with, e.g., an electrodeposited primer. The primer or primer surfacer layer may be cured or dried before application of the base coat coating composition. Wet-on-wet application is, however, also possible.

In step 2 the base coat layer of a base coat coating composition, preferably a water-based base coat coating composition is applied onto the primer or primer surfacer layer. The base coat coating composition comprises effect or solid-colour base coat coating compositions as are conventionally used in vehicle coating.

The base coat coating compositions may contain the conventional constituents of a pigmented base coat coating composition such as color and/or special effect pigments, fillers, one or more binders, optionally crosslinking agents, water and/or organic solvents and conventional coating additives.

Examples of binders are conventional film-forming binders and in case of water-based basecoat coating compositions water-dilutable film-forming binders familiar to the person skilled in the art, such as polyester resins, (meth)acrylic copolymer resins or polyester/(meth)acrylic copolymer hybrids and polyurethane resins or polyurethane/(meth)acrylic copolymer hybrids. These may be reactive functional or non-functional resins.

The base coat coating compositions may be physically drying or chemically crosslinking. Accordingly, the water-based coating compositions may contain crosslinking agents, such as, for example, polyisocyanate cross-linking agents. Selection of the optionally used crosslinking agents depends on the type of cross-linkable groups in the binders and is familiar to the person skilled in the art.

Preferably water-based base coat coating compositions comprise water-dilutable polyurethane resins, optionally in combination with other water-dilutable resins, e.g. water-dilutable (meth)acrylic copolymers, and with dispersants. Examples of water-dilutable polyurethane resins are those, for example, with a number average molecular weight Mn of 500 to 500,000 g/mol, preferably, of 1,100 to 300,000 g/mol, most preferably, of 5,000 to 300,000 g/mol, an acid value of 10 to 100 mg KOH/g, preferably of 20 to 80 mg KOH/g.

The water-based base coat coating compositions may contain conventional organic coating solvents, for example, in a proportion of preferably less than 20% by weight, particularly preferably of less than 15% by weight based on the entire coating composition.

Once the base coat coating composition, in particular the water-based base coat coating composition has been applied and optionally dried or cured, the clear coat coating composition is applied in step 3 of the process. The clear coat coating composition may here be applied onto the base coat layer either after drying or curing or after briefly flashing off, for example, at room temperature.

The resultant coatings may be cured at room temperature or be forced at higher temperatures, for example of up to 80° C., preferably at 40 to 60° C. They may, however, also be cured at higher temperatures of for example 80 to 160° C. Curing temperatures are mainly determined by the field of use as well as the by the type of cross-linker. The coating compositions are applied by conventional process, preferably by means of spray application.

Process (2): In step 1 the primer or primer surfacer coating composition is applied onto an optionally pre-coated substrate as described above for process (1). Once the primer or primer surfacer coating composition has been applied and optionally dried or cured, the pigmented single stage top coat coating composition is applied in step 2 of the process.

The resultant coatings may be cured as described above for process (1). The coating compositions are applied by conventional process, preferably by means of spray application.

The coating compositions and processes contemplated herein can be used in automotive and industrial coating, however, particularly advantageously in vehicle repair coating. Curing temperatures from 20° C. to 80° C., for example, particularly from 40° C. to 60° C. are used in vehicle repair coating. The coating compositions can also be used advantageously for coating large vehicles and transportation vehicles, such as, trucks, busses and railroad cars, where typically curing temperatures of up to 80° C. or higher than 80° C. are used. Furthermore, the coating compositions can be used for coating any industrial goods other than motor vehicles.

The invention will be explained in more detail on the basis of the examples below. All parts and percentages are on a weight basis unless otherwise indicated.

### Examples

### Preparation of Clear Coat Coating Compositions

### Free of Hydroxyl-Functional Binders

Clear coat coating compositions based on the aspartic acid ester DESMOPHEN®NH1420 (Bayer) have been activated with an activator based on the polyisocyanate DESMODUR®N3900 (asymmetric HDI-trimer, 100% solids, Bayer). The activator has been modified with an epoxy-functional silane (SILQUEST® A187 from Momentive Performance Materials). A non-modified activator, which does not contain the epoxy-functional silane, has been used for comparison.

Clear coat compositions have been formulated with the ingredients shown in Table 1 (in % by weight) and activators have been formulated with the ingredients shown in Table 2 (in % by weight).

TABLE 1

| | | | |
|---|---|---|---|
| DESMOPHEN ®NH1420 | Aspartic acid | Bayer | 65.00 |
| | ester | | |
| n-Butylacetate | Solvent | | 27.566 |
| Propyleneglycol | Solvent | | 2.10 |
| methylether | | | |
| acetate | | | |
| Butylglycol acetate | Solvent | | 2.00 |
| TINUVIN ® 384 | UV absorber, | BASF | 2.40 |
| | benzotriazole | | |
| | type | | |
| TINUVIN ® 292 | Hindered amine | BASF | 0.92 |
| | light stabilizer | | |
| BAYSILONE ® OL17 | Silicone based | OMG | 0.014 |
| | flow additive | Borchers | |

TABLE 2

| | | | Compar- | Acti- | Acti- |
|---|---|---|---|---|---|
| | | | ative | vator | vator |
| | | | Activator | 1 | 2 |
| DESMODUR ® | Asymmet- | Bayer | 54.6% | 54.60% | 54.60% |
| N3900 | ric low | | | | |
| | viscous | | | | |
| | HDI-trimer | | | | |
| n- | Solvent | | 45.4% | 42.07% | 43.74% |
| Butylacetate | | | | | |
| Epoxy silane | Gamma- | Mo- | | 3.33% | 1.66% |
| SILQUEST ® | glycidoxy- | mentive | | | |
| A187 | propyl- | Perfor- | | | |
| | trimemoxy | mance | | | |
| | silane | Materi- | | | |
| | | als | | | |

The clear coat compositions and the activators have been mixed by hand in a 1:1 volume ratio in each case. The resulting coating compositions had a solid content of 61.5% and a practical VOC content below 3.5 lbs/gal (420 grams/liter) (Comparison: with Comparative Activator without epoxy silane; Example 1: with Activator 1; Example 2: with Activator 2).

The activated clear coat compositions were sprayed over a commercially available solid red (Rouge vif) 1K waterborne basecoat on panels coated with an electrodeposition coating (Elpo panels from ACT coated with E-coat ED6100H). The panels are coated with a commercially available two-component primer surfacer, which has been baked for 30 minutes at 60° C. and sanded prior to application of the basecoat. The basecoat layers have been flashed off for 45 minutes at room temperature before application of the clear coat compositions. The basecoats have been applied in a dry film thickness of about 20 μm. The clear coat compositions have been applied at 20° C./40% RH (relative humidity) with 2 cross coats with a DEVILBISS® GTI ProLite spray gun (nozzle 1.3, air cap TE20, with gravity feed). The clear coats have been applied in a dry film thickness of about 50 μm. The clear coats have been cured for one hour at room temperature

The coated panels have been aged for one week at room temperature before evaluation of the adhesion and high pressure cleaning.

TABLE 3
Dry adhesion

| | Comparison | Example 1 | Example 2 |
|---|---|---|---|
| X-hatch | 10 | 10 | 10 |
| #-hatch | 10 | 10 | 10 |
| Gloss 20° | 87 | 87 | 87 |
| Dullness | 1 | 1 | 1 |

TABLE 4
Wet adhesion after 4 days humidity cabinet

| | Comparison | Example 1 | Example 2 |
|---|---|---|---|
| X-hatch | 10 | 10 | 10 |
| #-hatch | 0(6) | 10 | 9(6) |
| Gloss 20° | 85 | 85 | 85 |

TABLE 5
Wet adhesion after 10 days humidity cabinet

| | Comparison | Example 1 | Example 2 |
|---|---|---|---|
| X-hatch | 5(6) | 10 | 10 |
| #-hatch | 0(6) | 10 | 10 |
| Gloss 20° | 84 | 84.5 | 86 |
| Dullness | 1.7 | 1.5 | 1.0 |

The results clearly show that the multilayer coatings prepared as contemplated herein have improved adhesion properties as can be seen on the basis of the wet adhesion after humidity cabinet. The multilayer coatings prepared according to the invention do not show base coat cohesion failure.

The alcohol resistance has been evaluated in a multilayer coating as described above, with the exception that the clear coat composition has been applied over a silver metallic one-component waterborne basecoat.

TABLE 6
Alcohol resistance

| | Comparison | Example 2 |
|---|---|---|
| Ethanol | 1 | 9 |
| n-butanol | 1 | 8 |
| isopropanol | 8 | 10 |

The results clearly show that the multilayer coatings prepared according to the invention have improved resistance towards alcohols.

The high pressure cleaning has been evaluated in a multilayer coating as described above, wherein the clear coat composition has been applied over a solid red (Rouge vif) 1K waterborne basecoat, over a silver metallic one-component waterborne basecoat and over a one-component red pearl metallic waterborne basecoat.

TABLE 7
High pressure cleaning

| | Silver | | Solid | | Red | |
|---|---|---|---|---|---|---|
| | metallic basecoat | | red basecoat | | pearl basecoat | |
| | Compar- | Exam- | Compar- | Exam- | Compar- | Exam- |
| | ison | ple 2 | ison | ple 2 | ison | ple 2 |
| % | 80 (2) | 50 (2) | 100 (2) | 20 (2) | 100 (2) | 30 (2) |
| failure | | | | | | |

The cured coatings as contemplated herein showed improved resistance towards high pressure cleaning.

### 2. Preparation of Clear Coat Coating Compositions Containing Additionally Hydroxyl-Functional Binders

The clear coat compositions have been activated with a polyisocyanate activator based on 54.4% DESMODUR®N3900 (asymmetric HDI trimer, 100% solids, Bayer) and on 45.6% n-butylacetate without an epoxy and silane functional compound (=Comparative Activator) and with the same activator, but containing additionally an epoxy and silane functional compound (=Activator 1 with 1.66% SILQUEST®A187 from Momentive Performance Materials). The clear coat formulations and the activators have been mixed by hand in a 1:1 volume ratio in each case. The NCO to (NH+OH) ratio has been kept constant at 1.27.

Clear coat compositions (CC1, CC2, Comp.CC2 and Comp.CC3) have been formulated with the ingredients shown in Table 8.

TABLE 8

| | | | | | Comp. | Comp. |
|---|---|---|---|---|---|---|
| | | | CC1 | CC2 | CC2 | CC3 |
| DESMOPHEN ® | Aspartic acid | Bayer | 65.00% | 48.75% | 32.50% | 32.50% |
| NH1420 | ester | | | | | |
| Polyester * | OH-functional | | | 20.31% | 40.63% | |
| | binder | | | | | |
| Acrylic | OH-functional | | | | | 56.52% |
| copolymer** | binder | | | | | |
| n- | Solvent | | 27.566% | 23.506% | 19.441% | 3.545% |
| Butylacetate | | | | | | |
| Propylene- | Solvent | | 2.10% | 2.10% | 2.10% | 2.10% |
| glycol | | | | | | |
| methylether | | | | | | |
| acetate | | | | | | |
| Butylglycolacetate | Solvent | | 2.00% | 2.00% | 2.00% | 2.00% |
| TINUVIN ® | UV absorber, | BASF | 2.40% | 2.40% | 2.40% | 2.40% |
| 384 | benzotriazole | | | | | |
| | type | | | | | |
| TINUVIN ® | Hindered | BASF | 0.92% | 0.92% | 0.92% | 0.92% |
| 292 | amine light | | | | | |
| | stabilizer | | | | | |
| BAYSILONE ® | Silicone based | OMG | 0.014% | 0.014% | 0.014% | 0.014% |
| OL17 | flow additive | Borchers | | | | |

* The polyester has been prepared as follows:
According to Example 8 of U.S. Pat. No. 6,277,497 an oligoester has been prepared as follows: 136 grams of MPE (mono pentaerythritol) were refluxed with 504 grams of methyl hexahydrophthalic anhydride for about one hour in 175 grams of BuAc (n-butylacetate). Then 480 grams of glycidyl pivalate were added and the mixture was refluxed until the acid value was below 1 mg KOH/g. BuAc was added till a theoretical solids content of 75% was achieved.
**The acrylic copolymer has been prepared as follows:
A four litre three-necked glass flask equipped with an agitator, contact thermometer, dropping funnel and condenser was charged with 480 grams of SOLVESSO ® 100 (mixture of aromatic hydrocarbons, onset boiling point of 164° C., Exxon) and 309.6 grams of CARDURA ® E10P (Hexion) and heated to reflux at about 170-175° C. A monomer/initiator mixture consisting of 708 grams of styrene, 708 grams of isobornyl methacrylate, 516 grams of 2-hydroxyethyl methacrylate, 158.4 grams of acrylic acid, 60 grams of di-tertiary-butylperoxide and 240 grams of SOLVESSO ® were added continuously from the dropping funnel over 5 hours to the reactor contents. The dropping funnel was rinsed with 40 grams of SOLVESSO ® 100 and the mixture refluxed till constant viscosity. The reactor contents were then diluted with 780 grams of methyl amyl ketone. The solids content was about 60% and the acid value about 23 mg KOH/g.
CC1: free of hydroxyl functional binder
CC2: with hydroxyl functional polyester, ratio aspartic acid ester:polyester 75:25 (solids on solids)
Comp. CC2: with hydroxyl functional polyester, ratio aspartic acid ester:polyester 50:50 (solids on solids)
Comp. CC3: with hydroxyl functional acrylic copolymer, ratio aspartic acid ester:acrylic copolymer 50:50 (solids on solids)

TABLE 9

| | CC1 | CC2 | Comp. CC2 | Comp. CC3 |
|---|---|---|---|---|
| | Activator 1 | Activator 1 | Activator 1 | Activator. 1 |
| Initial spray | 13″ | 13.4″ | 14.4″ | 18″ |
| viscosity | | | | |
| Viscosity after | 14″ | 20″ | 20″ | 60″ |
| 15 min. | | | | |
| Viscosity after | 16″ | 23″ | 23″ | — |
| 20 min. | | | | |
| Pot life | 50 min. | 15-20 min. | <15 min. | <<15 min. |

The spray viscosities have been measured at 20° C. in a DIN4 cup.

The results in Table 9 show that in case of Comparative CC2 and Comparative CC3 an increase in initial spray viscosity occurred and that the pot life has been significantly reduced.

Also, blending the aspartic acid ester with a hydroxyl functional polyester or acrylic copolymer (Comp. CC2 and Comp. CC3) resulted in a significant yellowing of the clear coat formulation (Table 10). The color of the clear coat formulation has been measured in the Hazen scale (based on ASTM D1209) on the BYK LCSIII device (Table 10).

TABLE 10

| | CC1 | CC2 | Comp. CC2 | Comp. CC3 |
|---|---|---|---|---|
| Initial | 76 | 73 | 70 | 98 |
| 2 weeks | 106 | 132 | 121 | 604 |
| storage at | | | | |
| 49° C. | | | | |
| 4 weeks | 146 | 177 | 223 | >1000 |
| storage at | | | | |
| 49° C. | | | | |

Adhesion (dry and wet adhesion) of the coatings has been evaluated after one week aging at room temperature. The panels have been coated as described in Example 1 by using the solid red (Rouge vif) commercially available one-component waterborne basecoat.

TABLE 12
Dry adhesion

| | CC1 | CC2 | CC1 | CC2 |
|---|---|---|---|---|
| | Comparative | Comparative | Acti- | Acti- |
| | Activator | Activator | vator 1 | vator 1 |
| X-hatch | 10 | 10 | 10 | 10 |
| #-hatch | 10 | 10 | 10 | 10 |

TABLE 13
Wet adhesion after 10 days humidity cabinet

| | CC1 | CC2 | CC1 | CC2 |
|---|---|---|---|---|
| | Comparative | Comparative | Acti- | Acti- |
| | Activator | Activator | vator 1 | vator 1 |
| X-hatch | 5(6) | 10 | 10 | 10 |
| #-hatch | 0(6) | 9(6) | 10 | 10 |
| DOI | 94 | 84 | 91 | 80 |
| Dullness | 1.4 | 8.1 | 3.7 | 11.4 |

The results show that the multilayer coatings prepared with the epoxy silane modified activator (Activator 1) according to the invention have improved adhesion as can be seen on the basis of the wet adhesion after humidity cabinet. The comparative clear coat compositions showed inacceptable adhesion due to base coat cohesion failure.

### Test Methods:

Potlife: the pot life of the compositions was measured by measuring the viscosity increase as a function of time. The pot life is defined as the time required for increasing the initial viscosity by 1.5. The pot life defines the period during which the clear coat composition is still easy to spray.

Adhesion: This test method is based on ASTM D2247-92 and ASTM D3359-92A.

Dry and wet adhesion have been evaluated with the cross-cut tape test (X-hatch). A grid hatch is made with a manual cross cut tester, where the lines are 1 mm apart from each other (#-hatch). The panels are brushed lightly to remove any detached flakes of coating. To ensure good contact with the film a scotch tape is placed over the grid and rubbed with a rubber eraser to ensure good contact. Within 60 to 120 seconds after application the tape is removed by seizing the free end and pulling it off rapidly back upon itself at an angle as close as possible to an angle of 180 degrees.

The dry adhesion is rated from 0 (total failure) to 10 (no failure) according to the extent of damage, which is described by photographic representations.

For the evaluation of wet adhesion the same method is used but here the panels are placed during 4 days and during 10 days in a humidity cabinet which is at 100% RH and 40° C.

The type of failure has also been evaluated (indicated between brackets):

1: substrate/paint failure

2: primer/topcoat failure

3: basecoat/clear coat failure

4: primer/primer failure

5: primer cohesion failure

6: basecoat cohesion failure

High pressure cleaning (HPC) resistance: This test is performed according to a test method based on Volvo specifications (STD 423-0015).

Before testing high pressure cleaning resistance, which reflects adhesion, an initial paint damage is made on the test panel by scribing two 0.5 mm scribe lines using a scribing tool with a flat shaving steel. The scribed lines are made down to the substrate, at right angles to each other to create a cross.

Water with a temperature of 50° C. is sprayed with a pressure of 150 bar on the damaged panel (d=4 cm) during 20 seconds. The distance between the gun and the panel amounts to 15 cm.

When the test is completed, the panel is wiped dry and the extension of the paint damage is rated. The % of paint removed from the panel is expressed, wherein 0% is best. The type of failure is mentioned between brackets (same legend as for adhesion).

Alcohol resistance: This test method is based on ISO2812-4. The purpose of this test method is to characterize the resistance of the coating towards alcohols. Before testing, the test panels are conditioned for 16 hours under standard conditions (23±2° C. and 50±5% relative humidity). A few drops of the alcohol are put onto the panel, covered with a small piece of filter paper and a watch glass. All panels with the spots are stayed overnight. The panels have been washed with water and wiped off. The spots on the panel have been inspected and compared with the non-exposed area for:

a. swelling, b. loss of gloss, c. color change, d. softness, e. other deviations.

Any change in film properties is not accepted.

The following rating scale has been used:
10=No evidence of spotting or distortion
9=Barely detectable spotting or distortion
8=Slight ring
7=Very slight discoloration or slight distortion
6=Slight loss of gloss or slight discoloration
5=Definite loss of gloss or discoloration
4=Slight etching or definite distortion
3=Slight lifting, bad etching or discoloration
2=Definite lifting
1=Dissolving of film

Gloss: measured with the micro TRI gloss device from Byk Gardner (Germany). The reflected light is measured at an angle of 20°.

Dullness: measured with a Wavescan-DOI apparatus from Byk Gardner (Germany). Structures smaller than 0.1 mm influence visual perception and therefore, the wavescan DOI measures with a CCD camera the diffused light caused by these fine structures. The parameter measured in this way is referred to as the ‘dullness’ of the coating. A lower value for dullness is preferred, with 1 as a minimum.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A coating composition comprising:
A) at least one polyaspartic acid ester,
B) at least one polyisocyanate cross-linking agent with free isocyanate groups, and
C) at least one compound with at least one epoxy group and at least one alkoxy silane group.

2. The coating composition of claim 1, wherein the at least one polyaspartic acid ester A) is a compound of Formula (I) 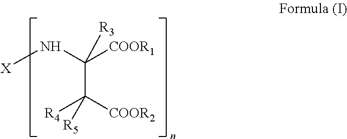
wherein X represents an n-valent organic group obtained by removal of the amino groups from a primary polyamine or polyetheramine; R1 and R2 are the same or different organic groups which are inert towards isocyanate groups, R3, R4 and R5 are the same or different and represent hydrogen or organic groups which are inert towards isocyanate groups; and n represents an integer with a value of at least 2.

3. The coating composition of claim 2, wherein n is 2 or 3.

4. The coating composition of claim 1, wherein the at least one compound with at least one epoxy group and at least one alkoxy silane group C) is a compound of Formula (III) 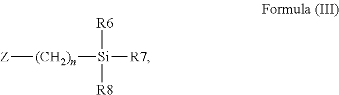
wherein Z represents an residue 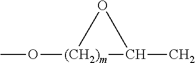
with m being 1-4;
or represents 3,4-epoxycyclohexyl; R6, R7, R8 are the same or different organic residues with 1 to 30 carbon atoms, provided that at least one of the residues R6, R7 and R8 is an alkoxy group with 1 to 4 carbon atoms; and n is 2, 3 or 4.

5. The coating composition of claim 4, wherein R6, R7 and R8 mutually independently mean identical or different alkoxy groups having 1-4 carbon atoms.

6. The coating composition of claim 1, wherein the coating composition comprises 0.25 to 5.0% by weight solids of component C), relative to the sum of the solids content of component A) and component B).

7. The coating composition of claim 1, wherein the coating composition is free of hydroxyl-functional binders.

8. The coating composition of claim 1, wherein the coating composition is free of blocked amines.

9. A process for the multilayer coating of substrates comprising the following steps:
1) applying a layer of a primer or primer surfacer coating composition onto an optionally pre-coated substrate,
2) applying a layer of a base coat coating composition containing color and/or special effect pigments onto the primer or primer surface layer,
3) applying a clear coat layer of a clear coat coating composition onto the base coat layer and
4) curing the clear coat layer, optionally together with the base coat layer, wherein at least one of the primer coating composition, and wherein the primer surfacer coating composition and the clear coat coating composition each independently comprise:
A) at least one polyaspartic acid ester,
B) at least one polyisocyanate cross-linking agent with free isocyanate groups, and
C) at least one compound with at least one epoxy group and at least one alkoxy silane group.

10. A process for the multilayer coating of substrates comprising the following steps:
1) applying a layer of a primer or primer surfacer coating composition onto an optionally pre-coated substrate,
2) applying a layer of a pigmented single stage top coat layer onto the primer or primer surface layer, and
3) curing the pigmented single stage top coat layer, optionally together with the primer or primer surface layer,
wherein at least one of the primer coating composition, and wherein the primer surface coating composition and the pigmented single stage top coat coating composition being the coating composition each independently comprise:
A) at least one polyaspartic acid ester,
B) at least one polyisocyanate cross-linking agent with free isocyanate groups, and
C) at least one compound with at least one epoxy group and at least one alkoxy silane group.

11. The process according to claim 9, wherein the base coat coating composition is a water-based base coat coating composition.

12. The process according to claim 9, wherein the substrate is a vehicle body or vehicle body part.

13.-16. (canceled)
